(19) United States
(12) Patent Application Publication
(10) Pub. No.: US 2009/0317526 A1
(43) Pub. Date: Dec. 24, 2009

(54) COFFEE BREWING SYSTEM

(76) Inventors: Christopher Tacklind, Menlo Park, CA (US); R. Brooke Hanson, Larkspur, CA (US)

Correspondence Address: Bay Area Technolgy Law Group PC, 500 Sansome Street, Suite 404, San Francisco, CA, 94111, US

(21) Appl. No.: 12/486,514

(22) Filed: Jun. 17, 2009

Related U.S. Application Data
(60) Provisional application No. 61/132,440, filed on Jun. 18, 2008.

(51) Int. Cl. A23F 5/24; A47J 31/44

(52) U.S. Cl. 426/433; 99/299; 99/287

(57) ABSTRACT

A device for brewing coffee including a basket for retaining coffee grounds, the basket having an opening to receive water at a user-selected temperature for contacting the coffee grounds within the basket. A control valve is provided for controlling the discharge of brewed coffee from the basket only after all of the water intended to be brewed has steeped within the coffee grounds.

### RELATED APPLICATIONS

The present application relies upon U.S. Provisional Application Ser. No. 61/132,440 filed on Jun. 18, 2008

### TECHNICAL FIELD

The present invention involves a device and method for using the device for brewing coffee in a manner far superior to current brewing techniques Coffee grounds are steeped with water for a predetermined and controlled period of time upon which an on-off valve is actuated to tailor the brewed beverage as desired by the end user

### BACKGROUND OF THE INVENTION

Coffee brewing has been carried out for a very long time. Coffee consumption is so wide spread that there are many connoisseurs having strong likes and dislikes although it is not difficult to reach consensus as to what constitutes finely brewed coffee. However, the technology available to achieve the desired end product is simply not currently available, at least to the extent of providing a consistent and repeatable product acceptable to the aficionado.

Historically, percolators have been in wide spread use. More recently, drip coffee machines have taken over as the brewing device of choice as they do a substantially better job at approximating an acceptable coffee beverage. However, the product produced by prior art devices is oftentimes highly variable and inconsistent. This is despite the fact that the precise chemistry of extraction is well known but only in a controlled laboratory setting is precise brewing a realistic possibility.

Conceptually, the creation of brewed coffee by contacting coffee grounds with water is quite simple As an example, a brewed beverage known as “cowboy coffee” is the result of merely placing grounds in a pan of hot water and letting it steep. Although there is some apparent ritual in settling the grounds to the bottom of the pan which may involve eggshells, grounds oftentimes can be found in the finished product which, again, can be highly variable in its drinkability.

As noted above, the use of a percolator has been quite common dating back for a century or more This device works somewhat like a microscopic geyser where boiling water is ejected within a central tube by steam bubbles. The water exits the top of the tube and drenches a bed of coffee grounds held in a basket. As the water works its way through the grounds, it dissolves volatile compounds from the grounds. This solution dribbles through holes in the bottom of the basket, returning it to the boiling caldron below. The partially brewed coffee is then reheated to its boiling point and returned to drench the coffee grounds in a continuous process until the desired extraction is achieved. Unfortunately, boiling the partially brewed coffee cooks the compounds in the brew ruining some of them.

During the time when the percolation process was in vogue, a Danish inventor perfected dual chamber vacuum brewing. This process involved heating water in a lower chamber, much like a percolator and upon initial boiling, a small amount of steam allowed to escape through a centrally located tube and through a bed of coffee grounds. When a vigorous boil is achieved, the water is transferred through the grounds to the top of the chamber However, unlike a percolator, the water is held in this chamber, mixed with the grounds in slurry and held there by steam from contacting the lower chamber. After a desired period of time is elapsed, heat is removed whereupon the steam cools and condenses producing a vacuum in the lower chamber. This vacuum causes the brewed coffee to proceed through filter holes as a result of the vacuum which was created leaving soggy grounds in the top chamber and freshly brewed coffee in the lower chamber.

Although the “French press” is another somewhat common way to brew coffee, clearly, the most common approach today is through the use of the drip process, created in the 1960's. In this process, water is heated to a boil in a chamber and is caused to dribble over grounds held in a brewing basket lined with a filter The filter and grounds keep the water from flowing through quickly having the net effect of letting the coffee steep in the hot water for awhile and allowing the water to flow through the grounds thus extracting compounds from the ground coffee The results achieved from this process are, however, far from ideal. This is because as the water slowly enters the chamber, and as the first few grounds are wetted, the brewing water begins immediately to flow out of the brewing basket, somewhat prematurely. Since this water has not been in contact with the grounds long enough, the initially brewed product is very weak. As the introduction of boiling water exceeds the drip of brewed coffee, the brewing basket fills and coffee flows, generally by gravity through a valve. As the last of the water used for brewing is held in contact with the grounds, they are in contact for too long of period such that, typically, 70% of the beverage which the drip coffee maker produces is under extracted or weak while 20% approaches optimum extraction metrics as defined by the Specialty Coffee Association of America while 10% is considered to be over extracted creating a bitter taste in the completed beverage This is despite the fact that ideal steeping time and flow through rates are now part of a standard published by the Specialty Coffee Association of America, the disclosure of which is incorporated by reference. Thus, for each grind, type of coffee and type of extraction desired, steeping and flow through times have been tabulated. However, the aforementioned processes only produce a crude approximation of this laboratory ideal.

### SUMMARY OF THE INVENTION

An automated, gravity based device for brewing coffee including a basket for retaining coffee grounds, the basket having an opening to receive water at a user-selected temperature for contacting the coffee grounds within the basket. A control valve is provided for controlling the discharge of brewed coffee from the basket only after all of the water intended to be brewed has steeped within the coffee grounds and an agitator used to create conditions within the brewing chamber that allow coffee to flow through either a gold filter, paper filter or combination of gold and paper filter relatively unimpeded and therefore at a much faster rate than conventional gravity based drip systems.

### BRIEF DESCRIPTION OF THE FIGURES

FIG. 1 is a perspective view of a simple conceptual depiction of the present invention.

FIG. 2a is a perspective view of one embodiment of a conceptual valve stoppering system for use in the present invention.

FIG. 2b is a schematic illustration of the operation of an on-off control valve for use herein.

FIG. 3 is a cross-sectional view of an embodiment of a device useful in practicing the present invention.

FIG. 4 is a side view illustrating a first embodiment for use in agitating water and coffee grounds held in a basket for carrying out the present invention.

FIG. 5 is both perspective and side views showing a second embodiment useful in agitating water and coffee grounds in practicing the present invention.

FIG. 6 is a side view of a system constituting an embodiment of the present invention in carrying out the method claimed herein.

### DETAILED DESCRIPTION OF THE INVENTION

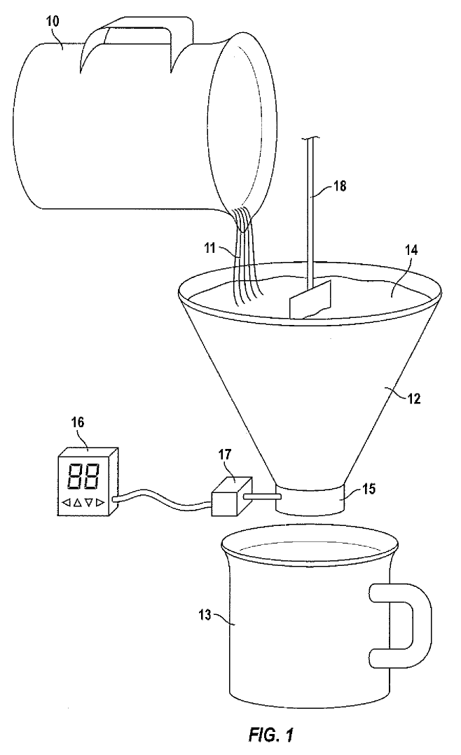

The fundamental concept of the present invention shown and incorporated in a very simplistic device is made the subject of FIG. 1. This device comprises basket 12 for retaining coffee grounds 14. FIG. 1 shows a simple carafe 10 dispensing hot water 11 into basket 12 employed as the appropriate brewing chamber. A user interface 16 includes a timer and control functionally connected to valve actuator 17 for controlling valve 15. This simple device can be used to carry out drip methodology employing conventional paper filters, steep and release methodology using conventional gold filters and filtered steep and release methodology using both gold and paper filters simultaneously. Employing any of these methodologies can result in precisely brewed coffee to the highest standards of the industry as measured by extraction of soluble substances, 20 to 22% being the preferred standard for coffee tasting professionals. As an alternative, this invention can brew coffee to a user's personal taste preferences repeatedly by simply actuating valve 15 appropriately.

As noted from the above discussion, regardless of the brewing type employed, common to all brewing methodologies employing the present invention is that the desired amount of water corresponding to the desired amount of brewed coffee is introduced all at once into basket 12 at an optimal temperature creating a slurry of water and coffee grounds Ideally, the slurry is agitated such as by paddle agitator 18 connected to a suitable motor (not shown) in order to enhance saturation of the coffee grounds with water 11. Agitation also acts to accelerate brewing, the brewed beverage is then either metered out over a preselected brew cycle time (drip methodology), or steeped and released all at once over a desired steep cycle (steep and release and/or filtered steep and release) It should thus be apparent that the present invention provides precise control over both the time that the developing beverage is in contact with the coffee grounds and the rate at which extraction takes place. Thus, a user of the present invention is provided with controls enabling he or she to produce different tastes and body profiles for the brewed coffee as desired.

In referring again to FIG. 1, user interface 16 can be established to select a user-desired steeping time and flow time through control valve 15 with or without the use of agitator 18 Once water 11 is introduced to basket 12 having coffee grounds residing therein, a first timer is initiated by pressing an appropriate “start button” (FIG. 6) or by any other means Actuation can commence any one of a number of ways such as by providing a switch activated upon closing a lid, etc.

Control valve 15 remains closed initially upon the introduction of water 11 to basket 12 corresponding to a preselected steeping time. Thereupon, a flow time is initiated. In the prior art, attempts were made to carefully open a valve a small amount so that coffee would flow for a period of minutes Such a valve, however, is fraught with problems as it must stay consistent over the lifetime of the system which may last for years. Further, small openings are prone to clogging and are difficult to clean.

By contrast, preferably, the present invention employs valve 15 which is either fully open or fully closed. Such valves are referred to as bang-bang servos. These valves usually operate under the theories of pulse length modulation and pulse frequency modulation.

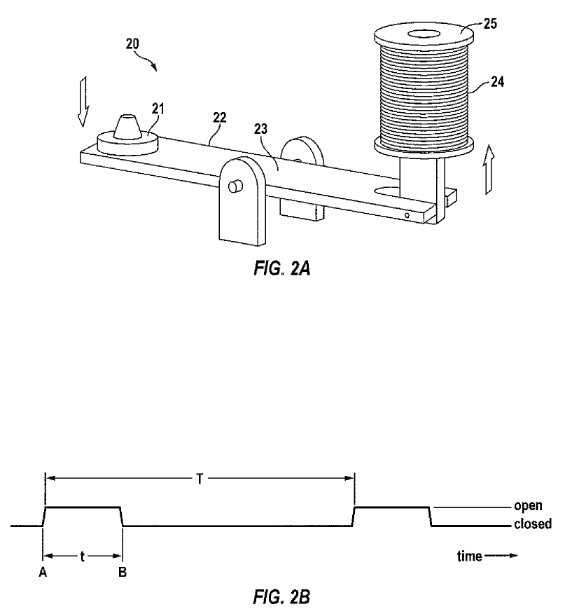

Reference is made to FIG. 2 illustrating, in a simplistic fashion, an embodiment employing a bang-bang servo. Specifically, FIG. 2a depicts a normally closed solenoid actuator valve 20 suitable for pulse length modulation. This includes a rubber seal 21 at one end of rocker 22. Near the center of the rocker is pivot 23 and on an end opposite to rubber seal 21 is compression spring 24 and solenoid 25.

User interface module 16 includes software timers and a counter for a number of valve cycles. A typical timing diagram for the cycles are shown in FIG. 2b. With each cycle, the valve quickly transitions from closed to open at the beginning of the pulse labeled “A.” This opens the valve fully as shown in FIG. 2b and after a short time “t”, the pulse stops at “B.” Return spring 24 quickly closes the valve fully and the time between the pulses “T” is determined for the particular design so that the number of pulses of length “t” drains most or all of the brewed coffee.

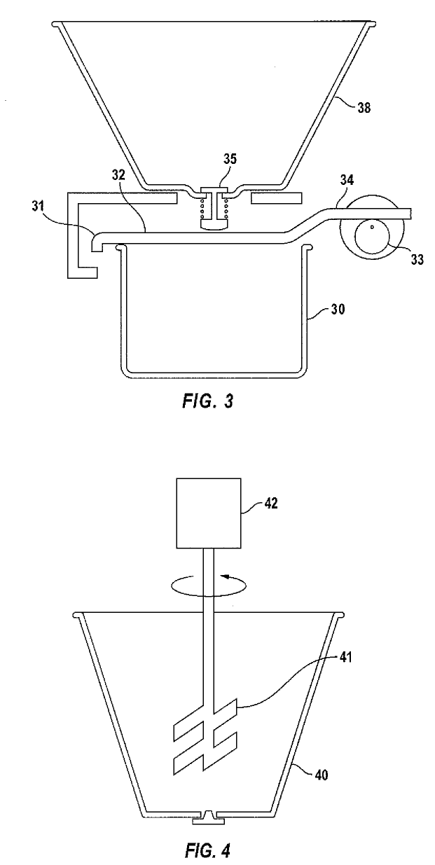

There is certainly other embodiments besides solenoid 25 which can be employed in carrying out the present invention In this regard, reference is made to FIG. 3.

As an illustration, rotary cam 33 is controlled to turn at a preselected frequency and duration to selectively open valve 35. This creates an “off-on-off” valve. With each actuation cycle, a reasonably consistent bolus of coffee is released. A finite number of these will empty basket 38 of brewed coffee. To achieve the desired overall drip time, the period between cycles is selected This is an example of pulse frequency modulation. The period or frequency may be continuously modified to precisely create the desired average flow rate. Clearly, valve 35 is either fully closed or fully open, albeit for short periods of time. Correspondingly, physical openings in the valve may be large. This allows for easy cleaning and small build up in such large openings will have little effect upon the size of the discharged bolus of coffee. Corrections to pulse length or number of pulses or their pulse frequency are readily made through the user interface if necessary.

As noted by reference to FIG. 3, the device used in practicing the present invention can be as simple as a see-saw mechanism in which carafe 30 supports lever 32 at end 31. Rotary cam 33 is positioned to lift end 34 of lever 32. Valve 35 is positioned substantially at the center of the lever. Actuation of the cam will affect the valve if and only if carafe 30 is in place. As a preferred embodiment, the lever is attached to brewing chamber or basket 38. Cam 33 can be programmed to stay closed as a last step in the brewing cycle in order to keep the last dregs of coffee in basket 38. It is noted that the architecture of FIG. 3 is that of a typical safety drip valve commonly employed in domestic drip coffee makers. This valve opens only if a coffee pot is in place as a safety feature to ensure that scalding hot coffee is not drained out of the machine.

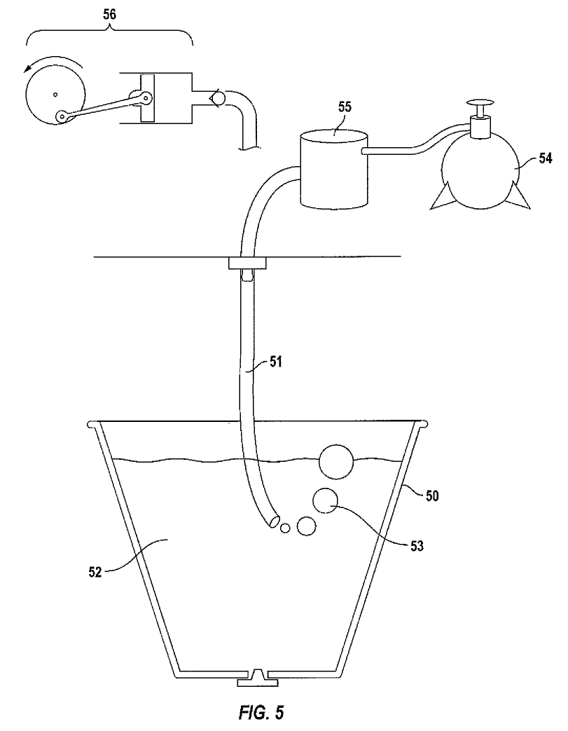

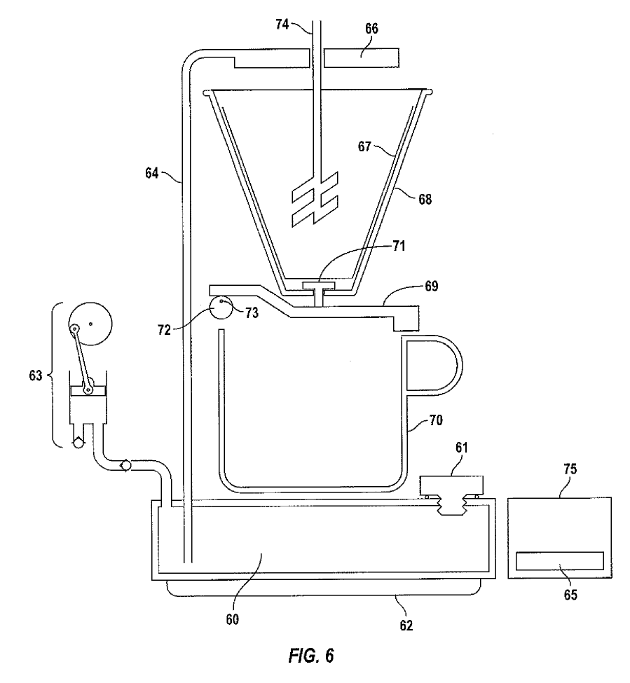

As noted previously, in order to enhance the intimate mixing of the water and coffee grounds in the appropriate basket or brewing chamber, agitation is employed as a preferred embodiment. Virtually any type of agitation can be used in carrying out the present invention. FIG. 4 shows one such embodiment in which paddle 41 is inserted within basket 40 rotated through the use of motor 42. A gentle motion of element 41 in a linear, circular or random pattern can act to stir the slurry in basket 40. Various shapes of mixing elements may prove more or less efficacious and facilitate cleaning. For example, a ball on the end of a stick can be easily rinsed. By turning the ball about the stick will not provide very much mixing but positioning the ball off axis will enhance mixing action. In summary, any type of mechanical mixing device should be considered within the scope of the present invention Along these lines, reference is made to FIG. 5.

In turning to FIG. 5, small pneumatic tube 51 is lowered into slurry 52 contained within basket or brewing chamber 50. A small bolus of air 53 is delivered at intervals to provide the appropriate mixing Air used for this purpose can be created from compressed source 54 modulated by valve 55 from pump 56. A mechanical or electrical control means could be provided for the timing and actuation or modulation of valve 55 if desired.

Through the use of agitation, be it the embodiments of FIG. 4, FIG. 5 or otherwise, mixing of the grounds and hot water is enhanced. If agitation is continued into the brewing cycle, improved uniform extraction, shorter extraction times and improved evacuation of the basket or brewing chamber are achieved. Thus, brewing times are shortened and maximum use of coffee grounds is achieved. These improved results are not surprising for through the use of agitation, most of the coffee grounds remain suspended during the entire brewing time to participate actively in the extraction process. Agitation also speeds the extraction rate reducing extraction time needed for all grinds. The improvement is pronounced for course grinds having the effect of reducing time needed for the brewing cycle.

Agitation also benefits time necessary to release the coffee from the brewing chamber. With most grounds in suspension, no plug of coffee is formed at the bottom of the filter Thus, coffee is allowed to flow out relatively unimpeded

Regarding the steeped methodology whereby coffee is steeped and then released all at once through a gold filter, this methodology allows a small amount of coffee sediment, oils and other beneficial organic particles into the beverage; coffee prepared using this methodology is virtually identical in body and taste profile to a press pot or French press methodology. The invention therefore represents an automated, gravity based, solution for press pot or French style coffees.

FIG. 6 depicts an example of the present invention for use in a residential setting. The complete self contained system includes water heating chamber 60 having filling port and stopper 61, electric heating element 62, transfer air pump 63, transfer tube 64, start button 65, spray head 66, filler basket 67 made part of brewing chamber 68, see-saw lever 69 of the type generally shown in FIG. 3, carafe 70, valve 71, motor 72 with cam 73, agitator 74 and user interface 75 containing control and time circuitry as discussed above. In use, one would pour water into heating chamber 60 while placing coffee grounds in filter basket 67 Thereupon, start button 65 is initiating the control circuitry. In doing so, water within heating chamber 60 is heated to a preselected temperature by heating element 62 and is fed through transfer tube 64 and into spray head 66 for spraying water into brewing chamber 68 Valve 71 remains closed until the coffee grounds are steeped with water while employing, in a controlled fashion, agitator 74. At the appropriate time, motor 72 is actuated turning cam 73 for selectively opening valve 71 by selectively raising and lowering see-saw lever 69. Again, programming is generally carried out for actuating valve 71 in a controlled fashion as an on-off valve employing frequency or pulse width modulation as desired Temperature in the boiling chamber or other components may be monitored by the controls as well. A temperature set point or temperature rise rate may be used to indicate that the water has transferred to the brewing chamber.

A start button is of particular utility in a residential unit for several reasons. To the user, it is a convenient “one touch” user interface. However, functionally, it does much more than meets the eye. For example, the heating element necessarily draws a great deal of current. As such, the start button is also a high current switch. This eliminates the need for an expensive silicon power device or mechanical relay. The start switch may also be temperature sensitive causing it to turn off after water has boiled as the heat arises above water's boiling point. In some applications, steam build up can be configured to push the switch into its off position. These events may coincide with the transfer of water from the heating chamber to the brewing chamber In a preferred embodiment, a small detector can be included to sense the state of the start button and its switch. This can provide a valuable and inexpensive input to the controller to initiate brew timers as needed.

In office or commercial brewing applications, other conveniences may be found appropriate such as coffee grinders, preheating chambers, hot water transfer pumps and special user interfaces. A debit card may be used in a commercial setting. This can reduce the labor of a barista. In a preferred embodiment, it may also be used to command the settings preferred by the customer. A display could be provided with a welcoming message to a customer or provide customer choices such as “your standard brew” or “other.” The desired bean type, grind, brew parameters could all be selected by the user or automatically processed with the swipe of a card.

Although the present invention has been described with respect to the brewing of coffee, it could also be employed for the brewing of other beverages, such as tea. The preferred embodiment as discussed above represent only examples of the present invention, the scope of which being that of the claims which follow.

What is claimed is:

1. A device for brewing coffee comprising a basket for retaining coffee grounds having an opening to receive water at a user-selected temperature for contacting said coffee grounds and a control valve for controlling the discharge of brewed coffee from said basket only after all of the water intended to be brewed has steeped with said coffee grounds.

2. The device of claim 1 wherein said control valve is an on-off valve.

3. The device of claim 2 wherein said control valve is pulse-frequency modulated.

4. The device of claim 2 wherein said control valve is pulse-length modulated.

5. The device of claim 1 further comprising an agitator for agitating the water and coffee grounds within said basket.

6. The device of claim 5 wherein said agitator is a rotating paddle agitator.

7. The device of claim 5 wherein said agitator comprises an air pump and feed line for introducing air to the water and coffee grounds within said basket.

8. The device of claim 1 wherein said basket supports a paper filter within which said coffee grounds reside.

9. The device of claim 1 wherein said basket supports a gold filter within which said coffee grounds reside

10. A device for brewing coffee comprising a reservoir for selectively retaining water to be used for brewing, a heating element for raising the temperature of water held in said reservoir to a user-selected temperature, a basket for retaining coffee grounds, a transfer line for selectively transferring said water to said basket and a control valve for controlling the discharge of brewed coffee from said basket wherein said control valve opens the discharged coffee from said basket only after all of the water intended to be brewed has steeped with said coffee grounds.

11. The device of claim 10 wherein said control valve is an on-off valve.

12. The device of claim 11 wherein said control valve is pulse-frequency modulated.

13. The device of claim 11 wherein said control valve is pulse-length modulated.

14. The device of claim 10 further comprising an agitator for agitating the water and coffee grounds within said basket.

15. The device of claim 14 wherein said agitator is a rotating paddle agitator.

16. The device of claim 14 wherein said agitator comprises an air pump and feed line for introducing air to the water and coffee grounds within said basket.

17. The device of claim 10 wherein said basket supports a paper filter within which said coffee grounds reside.

18. The device of claim 10 wherein said basket supports a gold filter within which said coffee grounds reside.

19. A method for brewing coffee comprising providing a basket for retaining coffee grounds, introducing said coffee grounds to said basket, introducing water to said coffee grounds, providing a control valve for controlling the discharge of brewed coffee from said basket and selectively opening said control valve only after all of the water intended to be brewed has steeped with said coffee grounds.

20. The method of claim 19 wherein said control valve is operated as an on-off valve.

21. The method of claim 20 wherein said control valve is pulse-frequency modulated.

22. The method of claim 20 wherein said control valve is pulse-length modulated.

23. The method of claim 19 wherein said water and coffee grounds are agitated within said basket.

24. The method of claim 23 wherein said agitation is created by rotating a paddle

25. The method of claim 23 wherein said agitation is caused by the introduction of air bubbles within said basket.

26. The method of claim 19 wherein a paper filter is applied to said basket prior to the addition of said coffee grounds.

27. The method of claim 19 wherein a gold filter is applied to said basket prior to the addition of said coffee grounds.

28. The method of claim 19 wherein said valve is controlled to retain said water and coffee grounds for a preselected period of time.

29. The method of claim 19 wherein said valve is controlled for discharging brewed coffee from said basket at a preselected rate
